(19) United States
(12) Patent Application Publication
(10) Pub. No.: US 2011/0208797 A1
(43) Pub. Date: Aug. 25, 2011

(54) Geolocation-Based Management of Virtual Applications

(75) Inventor: Danny Kim, Bellevue, WA (US)

(73) Assignee: Full Armor Corporation, Boston, MA (US)

(21) Appl. No.: 13/032,262

(22) Filed: Feb. 22, 2011

Related U.S. Application Data
(60) Provisional application No. 61/306,720, filed on Feb. 22, 2010.

(51) Int. Cl. G06F 15/173; G06F 15/16

(52) U.S. Cl. 709/202; 709/225

(57) ABSTRACT

Actions are performed upon a virtualized application based on the geolocation of the endpoint device derived from the Internet connected IP address or connected GPS device. Actions include reporting to a server database, alerting a specified user, or removing end-user access to the virtual application by uninstalling or installing the virtual application based on predefined geofences.

### RELATED APPLICATION

This application claims the benefit of U.S. Provisional Application No. 61/306,720, filed on Feb. 22, 2010, the entire teachings of which application are incorporated herein by reference.

### BACKGROUND

Virtual applications are computer software applications that execute in a heterogeneous software application layer, typically through a virtual application agent, that isolates the installed virtual application from the operating system or operating environment that it is operating within. The virtual applications are streamed or delivered and installed to the virtual application agent, over a network from a central location and enable end-user usage, without being installed in the end-user operating environment, and enable administration from a central location.

Every application depends on its operating system for a range of services, including memory allocation, device drivers, and much more. Incompatibilities between an application and its operating system can be addressed by either server virtualization or presentation virtualization. Application virtualization may address incompatibilities between two applications installed on the same instance of an operating system.

Applications installed on the same device commonly share configuration elements, yet this sharing can be problematic. For example, one application might require a specific version of a dynamic link library to function, while another application on that system might require a different version of the same DLL. Installing both applications creates a situation where one of the applications may overwrite the version required by the other causing one of the applications to malfunction or crash. To avoid this, organizations often perform extensive compatibility testing before installing a new application, an approach that's workable but quite time-consuming and expensive.

Application virtualization may create application-specific copies of all shared resources. Each application may have a separate configuration of potentially shared resources such as registry entries, dynamic linked libraries, and other objects that may be packaged with the application. The package may be executed in a cache, creating a virtual application. When a virtual application is deployed, it uses its own copy of these shared resources.

A virtual application may be more easily deployed. Since a virtual application does not compete for dynamic linked library versions or other shared aspects of an application environment, compatibility testing may be reduced or eliminated. In many instances, some applications may be used in a virtual manner while other applications may be operated natively.

### SUMMARY

In embodiments, actions are performed upon a virtualized application based on the geolocation of the endpoint device derived from the Internet connected IP address or connected GPS device. Actions include reporting to a server database, alerting a specified user, or removing end-user access to the virtual application by uninstalling or installing the virtual application based on predefined geofences.

Accordingly, in one aspect, a computer device includes a processor, a memory storing a device operating system and a cache storing a virtual application package that includes geofence policies associated with a virtual application. A first agent executing on the processor is configured to load the geofence policies from the cache and take action with respect to the virtual application based on the geofence policies and a geolocation information signal indicating the geolocation of the device. The virtual application package may include the virtual application.

The computer device may include a second agent executing on the processor that is configured to operate the virtual application in isolation from the device operating system subject to the action taken by the first agent.

Each geofence policy may include a geofence that defines a geographical area and one or more conditions and corresponding actions associated therewith.

The first agent may be configured to take action to enable or disable access to the virtual application based on the geolocation of the device relative to the geofence.

The first agent may be configured to take action with respect to the virtual application for the condition where the device is inside or outside the defined geographical area of the geofence for a time duration.

In another aspect, a server includes a processor and a memory, a database storing a plurality of virtual applications, a geofence specification interface configured to define a plurality of geofence policies, a virtual application administration interface configured to create a plurality of virtual application packages from the plural virtual applications and plural geofence policies, and a network interface configured to deliver the virtual application packages to a plurality of computer devices.

Each geofence policy includes a geofence that defines a geographical area and one or more conditions and corresponding actions associated therewith. The conditions may include whether the computer device is inside or outside the geofence and a time duration for the computer device inside or outside the geofence, and the actions may include enabling or disabling operation of the virtual application at the computer device based on the condition.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments.

FIG. 1 illustrates example configurations of virtualized application infrastructure.

FIG. 2 illustrates a block diagram of an example computer device.

FIG. 3 illustrates a block diagram of an example server.

FIG. 4 shows a high level representation of a software embodiment.

FIG. 5 illustrates an example process for setup and administration.

FIGS. 6A-6C show user interfaces for defining example geofences.

FIGS. 7A and 7B illustrate example formats for defining Geolocation Targeting Rules.

FIG. 8 illustrates an example of retrieval of geofences from a server.

FIG. 9 shows an example agent geofence enforcement process.

### DETAILED DESCRIPTION

A description of example embodiments of the invention follows.

Embodiments of the disclosure bring an active layer of management and security to virtual applications infrastructure by enforcing rules based on the geolocation of the device that is running the virtual applications.

Geolocation is generally the term used to refer to identification of an actual geographic location of an object, such as a cell phone or an Internet-connected computer device. Geolocation may refer to the practice of determining the location, or to the actual determined location.

There are at least two ways to obtain the geolocation of a cell phone or computer device. One way is simply to include a Global Positioning System (GPS) adapter in the device itself. Another way, which is less accurate, is based on resolving the IP address provided by the network adapter when the device is connected to the Internet.

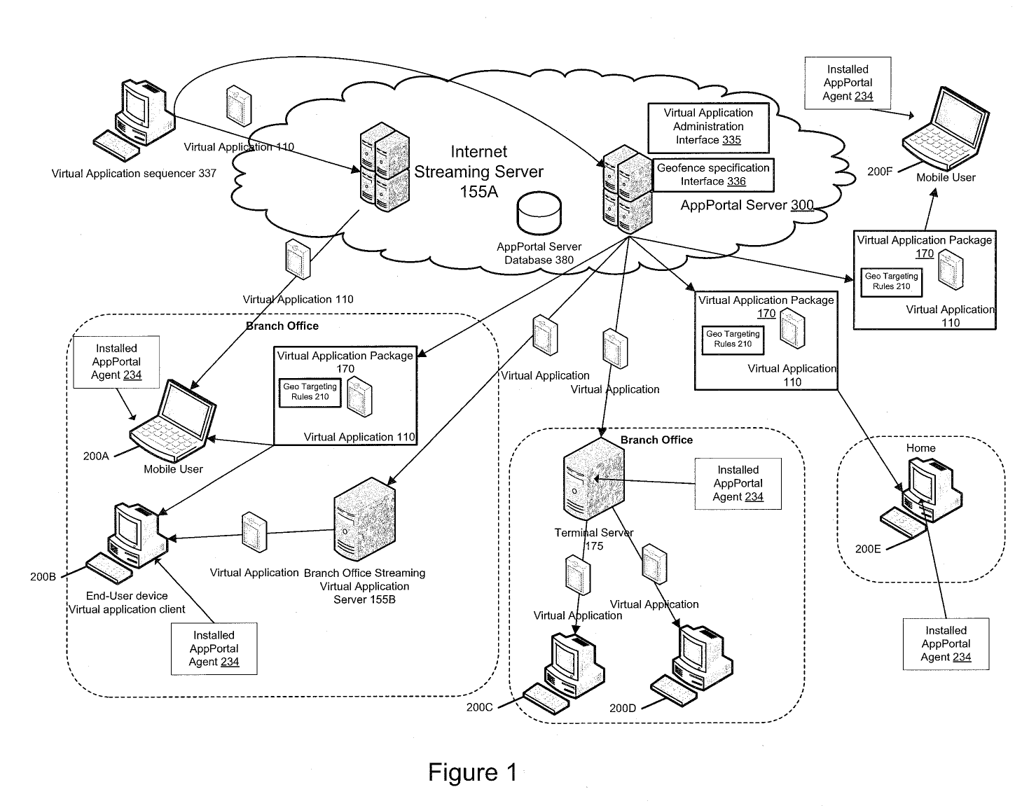

Referring now to FIGS. 1 to 4, example configurations of virtualized application infrastructure are shown. Embodiments may operate alongside an existing virtual application infrastructure such as Microsoft Virtual Application Server (also called App-V) or Citrix XenApp®. Virtual application infrastructure may include a virtual application agent 235 which provides the heterogeneous environment that abstracts a sequenced virtual application from a device operating system 232 and a virtual application sequencer 337. The virtual application sequencer 337 performs the function of converting a standard application into a virtual application suitable to operate within the virtual application agent 235.

In an embodiment the system includes an agent, referred to herein as AppPortal Agent 234, and a server application, referred to herein as AppPortal Server 300, which operates within a cloud computing environment, on a server computer system on the Internet, or on a server computer system in a LAN/WAN environment.

In the cloud computing environment, the AppPortal Server operates as a secure, cloud-based service based on a computing paradigm in which a “cloud” of devices and services are configured to allow multiple clients or agents to be serviced simultaneously within the cloud without degradation to computing performance. The term “cloud” refers to a collection of data and resources (e.g., hardware and/or software, data storage services, data processing services) accessible by a user over a network and maintained by an off-site or off-premises party (e.g., third-party). An example of a third-party offering for cloud-based hosting is Microsoft Windows Azure™

The virtualization application infrastructure is acted upon by the AppPortal system with the AppPortal Agent 234 interacting with the virtual application agent 235 using standard application programming interfaces made available by the virtual application agent 235, and the AppPortal Server 300, providing the centralized administration of the virtualized applications as a centralized data-store and control mechanism in deploying the virtual applications. In another embodiment, the virtual application infrastructure also includes a streaming server 155A which enables the virtual application agent 235 to access virtual applications which are streamed over the Internet from the streaming server 155A.

In other embodiments, the functionality of the AppPortal Agent 234 and the functionality of the virtual application agent 235 may be combined in a single agent.

The AppPortal Server 300 provides a repository of virtualized applications 110 and virtual application packages 170 that include geofence targeting rules or geofence policies 210 applied to the virtual applications, an interface for the creation and administration of virtualized application packages 335, and a geofence specification interface 336 for editing the geofence targeting rules/geofence policies 210. An AppPortal Server database 380 represents a persistent storage repository for AppPortal Server, AppPortal Agent, user and device information.

Virtual applications 110 may also be streamed to the client from a variety of types of virtualization servers such as a branch office streaming server 155B or from a web server which delivers the sequenced applications to the device virtual application agent 235 in parts as required by the end-user. Another alternative delivery method is to set up virtual applications 110 on a terminal server 175 and make these applications available to users via a terminal session.

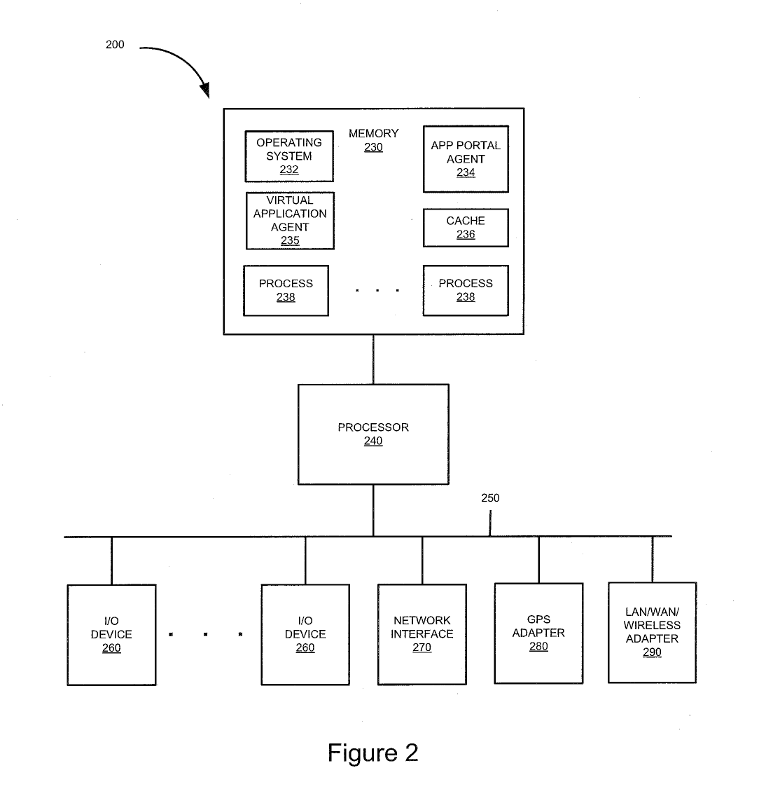

FIG. 2 is a block diagram of an embodiment of an example computer device 200. The computer device 200 comprises a memory 230 coupled to a processor 240 which in turn is coupled to one or more input/output (I/O) devices 260, network interface 270, GPS adapter 280 and LAN/WAN/wireless adapter 290 via an I/O bus 250. The I/O devices are conventional I/O devices such as disk units, keyboards, displays and the like.

The network interface 270 comprises circuitry configured to interface the computer device 200 to the AppPortal Server 300 via a network. To that end, the network interface 270 comprises conventional interface circuitry that incorporates signal, electrical, and mechanical characteristics and interchange circuits needed to interface with the physical media of the network and protocols running over that media.

The GPS adapter 280 is configured to obtain the geolocation of the computer device 200. The LAN/WAN/wireless adapter 290 is configured to, among other functions, resolve an IP address when the computer device 200 is connected to the Internet so that the device geolocation can be determined.

The processor 240 is a conventional central processing unit (CPU) configured to execute instructions and manipulate data contained in the memory 230. The memory 230 is a conventional random access memory (RAM) comprising, e.g., dynamic RAM (DRAM) devices. Memory 230 contains an operating system 232, App Portal Agent 234, virtual application agent 235 and cache 236. It should be noted that memory 230 may contain other processes 238 that are used to perform various functions on the computer device 200.

The operating system 232 is a conventional operating system that comprises computer executable instructions and data configured to support the execution of processes, such as App Portal Agent 234 and virtual application agent 235. Specifically, operating system 232 is configured to perform various conventional operating system functions that, e.g., enable processes to be scheduled for execution on the processor 240 as well as provide controlled access to various resources of the computer device 200, such as memory 230.

The App Portal Agent 234 comprises computer executable instructions and data configured to, as will be described further below, manage access to virtual applications based on geofence policies. The virtual application agent 235 comprises computer executable instructions and data configured to, as will be described further below, to operate virtual applications based subject to the geofence policies managed by the App Portal Agent 234.

The cache 236 is a secure data structure configured to store virtual application packages 170 downloaded from the AppPortal Server 300.

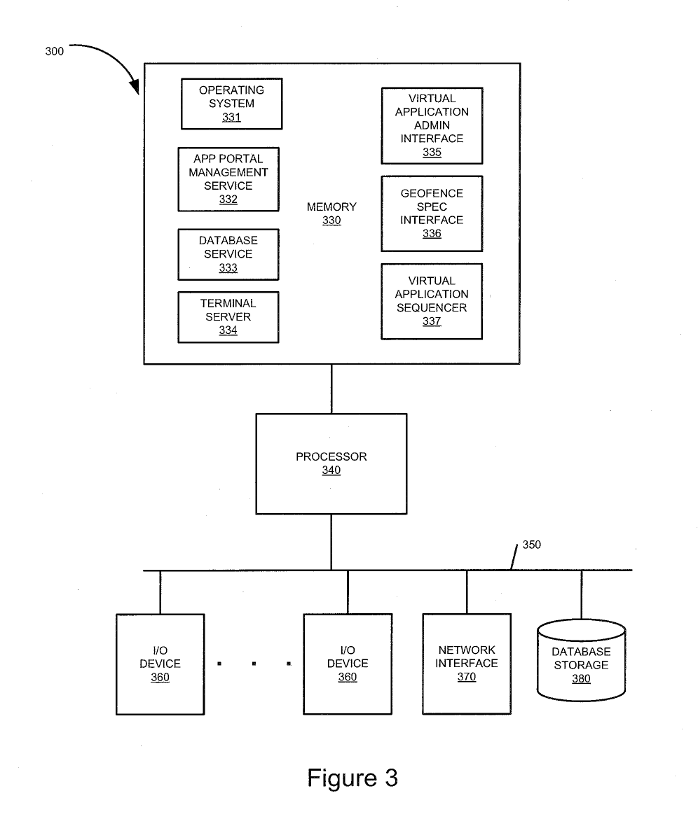

FIG. 3 is a block diagram of an embodiment of the AppPortal Server 300. Server 300 comprises a memory 330, a processor 340 coupled to one or more I/O devices 360, a network interface 370 and a database storage 380. The processor 340 is a conventional CPU configured to execute instructions and manipulate data contained in memory 330. The I/O devices 360 are conventional I/O devices such as keyboards, storage units, display devices and the like. The network interface 370 is a conventional network interface that is configured to interface the AppPortal Server 300 with the network. To that end, the network interface 370 comprises conventional interface circuitry that incorporates signal, electrical characteristics and interchange circuits needed to interface with the physical media of the network and the protocols running over that media. The database storage 380 is a conventional storage medium that stores virtual applications 110, geofence policies 210 and virtual application packages 170.

The memory 330 is a conventional RAM comprising e.g., DRAM devices. Memory 330 contains an operating system 331, AppPortal management service 332, database service 333, terminal server 334, virtual application administration interface 335, geofence specification interface 336 and virtual application sequencer 337. The operating system 331 is a conventional operating system configured to schedule the execution of processes such as AppPortal management service 332, database service 333, terminal server 334, virtual application administration interface 335, geofence specification interface 336 and virtual application sequencer 337 on processor 340 as well as provide controlled access to various resources associated with AppPortal Server 300, such as the I/O devices 360, database storage 380 and network interface 370. An example of an operating system that may be used with the present invention is the Windows 2000 server operating system.

The AppPortal management service 332 comprises computer executable instructions configured to receive virtual applications 110 and geofence targeting rules/geofence policies 210 from database 380 and prepare virtual application packages 170. The database service 333 comprises computer executable instructions that are configured to maintain the virtual applications 110, geofence targeting rules/geofence policies 210 and virtual application packages 170 in the database on database storage 380. The terminal server 334 comprises computer executable instructions configured to enable an administrator to gain access to the AppPortal 300 for configuration management. The virtual application administration interface 335 comprises computer executable instructions for an administrator to manage the virtual application packages 170 and geofence target rules/policies 210. The geofence specification interface 336 comprises computer executable instructions configured to access geofence target rules/policies 210. The virtual application sequencer 437 comprises computer executable instructions configured to sequence the elements of the virtual applications 110.

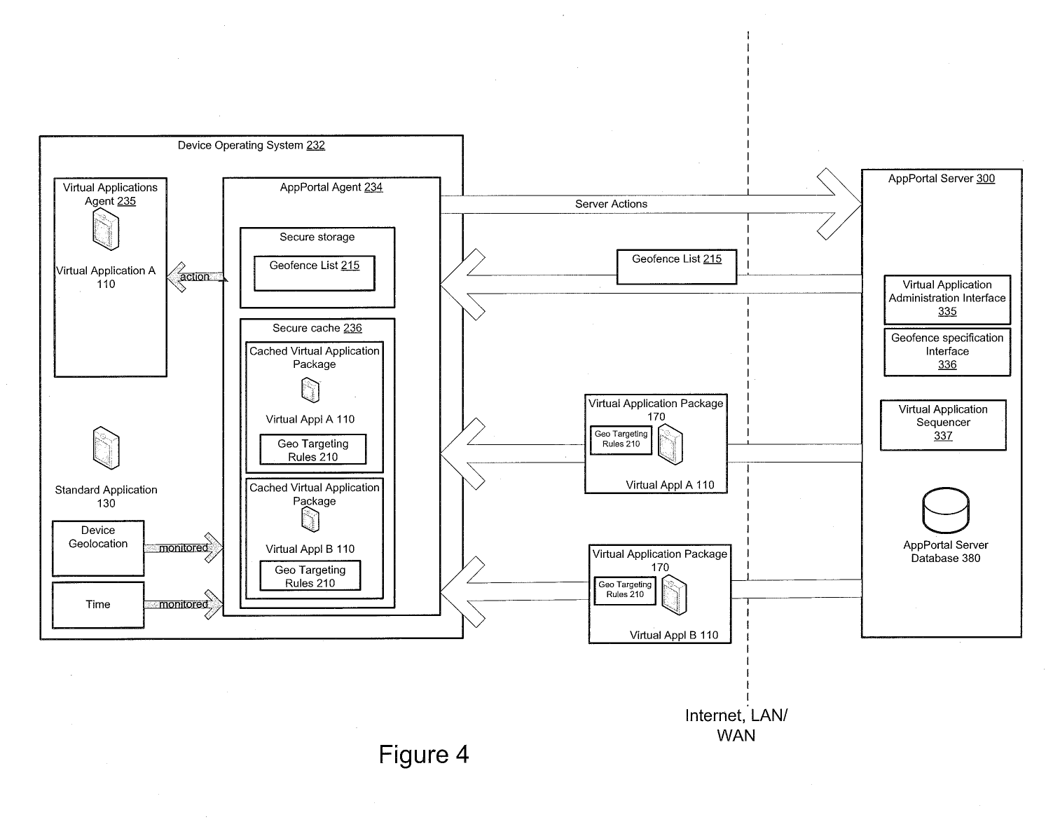

Referring now to FIG. 4, a high level representation of a software embodiment and the prominent software objects relevant to the embodiment are shown. The virtual application package 170 that is delivered from AppPortal Server 100 and stored in a secured cache 236 in the computer device 200 includes both the virtual application 110 and geofence targeting rules/policies 210 that relate to a particular geofence 120. A geofence 120 defines a virtual perimeter on a geographic area. A geofence 120 may be a simple circle defined by a centre coordinate and radius, or a more complex shape defined by vertices of a polygon, or a series of circular arcs. The geofence target rules/policies 210 apply a geolocation policy onto the virtual application. Based on the location of the device and the geofence targeting rules 210 that are applied to the virtual application, the AppPortal Agent 234 will either make the virtual application 110 accessible or not accessible to the user.

As shown in the example configuration of FIG. 4, there are two virtual applications that the user subscribed to but only virtual application A is made accessible to the user as geofence targeting rules 210 prohibit access to virtual application B based on the location of the device. It is also worth noting that virtual applications can run along side of traditionally installed standard applications 130.

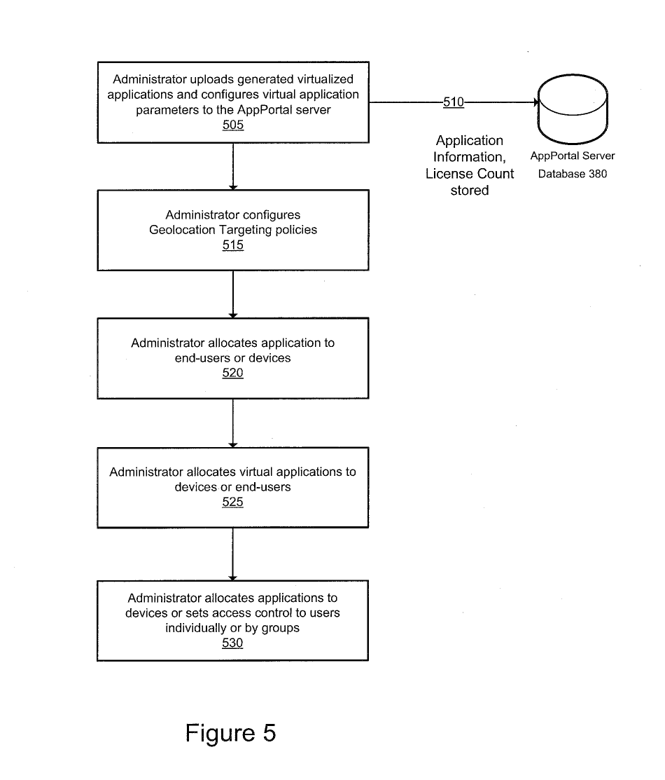

FIG. 5 illustrates a process for setup and administration. In an embodiment the virtual applications are sequenced or created from original software installations by third-party virtual application infrastructure. The generated sequenced software application is uploaded to the AppPortal Server 300 at step 505. Additional application information and an available license count is associated to the sequenced application at step 510 and stored in the AppPortal Server database 380. At step 515, the administrator configures geolocation targeting policies, and allocates standard applications (step 520) and virtual applications (step 525) to devices or end users. At step 530, the administrator may also allocate applications to devices or set access control to users individually or by groups.

Geofences are defined by an administrator of the AppPortal Server 300 using the geofence specification interface 336. The geofences may be defined using third-party mapping software and a graphical user interface or specified in terms of publicly known geospatial polygon definition standards. The geofences may be stored using publicly known standards such as the Open Geospatial Consortium, Inc. Geography Markup Language (GML) Encoding Standard. An example of a polygon definition is as follows:

<wfs:Insert>

<feature:Geofence>

<feature:the_geom>

<gml:MultiPolygon
xmlns:gml=“http://www.opengis.net/gml”;>

<gml:polygonMember>

<gml:Polygon>

<gml:outerBoundaryIs>

<gml:LinearRing>

<gml:coordinates decimal=“.”
cs=“,” ts=“

```
  ”>−105.663109375,40.1591796875 −107.068369375,38.2255859375
  −103.640625,37.7861528125 −
105.662109375,40.1591796875</gml:coordinates>
```

</gml:LinearRing>

</gml:outerBoundaryIs>

</gml:Polygon>

</gml:polygonMember>

</gml:MultiPolygon>

</feature:the_geom>

</feature:Geofence>

</wfs:Insert>

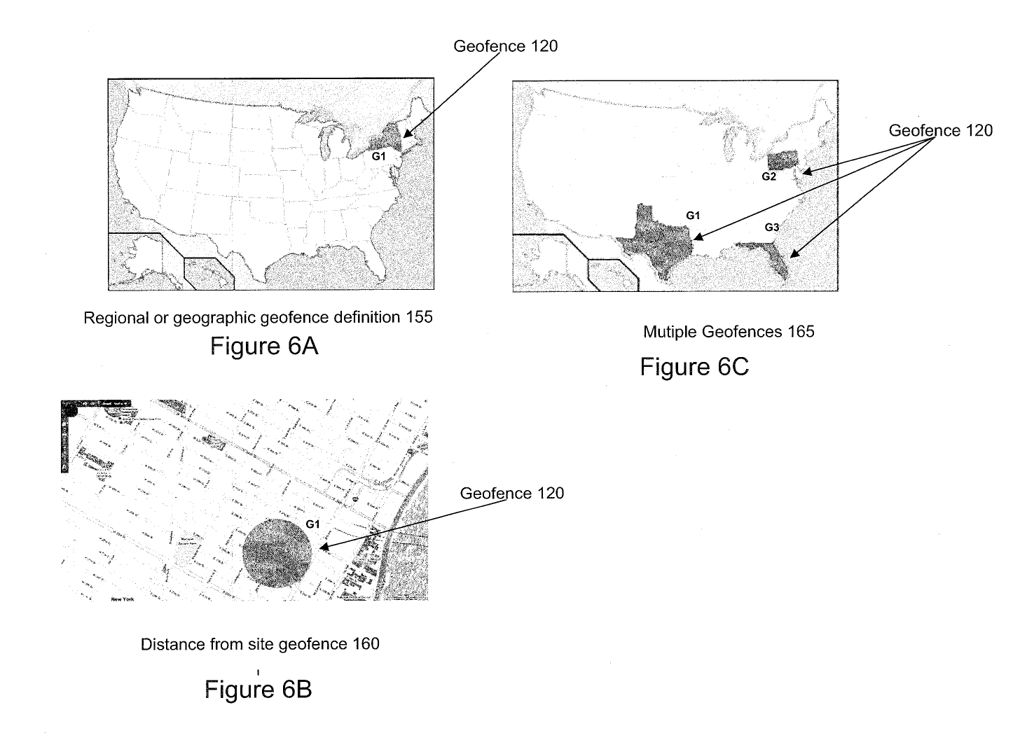

Referring more specifically to FIGS. 6A-6C, geofences may be defined by regional or geographic selection 155 (FIG. 6A) from a map or list displayed to the administrator, or can be defined by creating a discretionary geofence by using standard geofence rules. A geofence can be defined based on distance from a geographic point 160 (FIG. 6B). The geofences also may be defined as a list of discretionarily points or vectors representing the boundary of the geofence, represented as a geometric polygon, or selected from a list of predefined geofences representing geographic location such as a state, national, city, regional area, standard neighborhoods, geographic features. Multiple geofences 165 may be defined and stored within a single geofence (FIG. 6C), or stored separately as individual geofences.

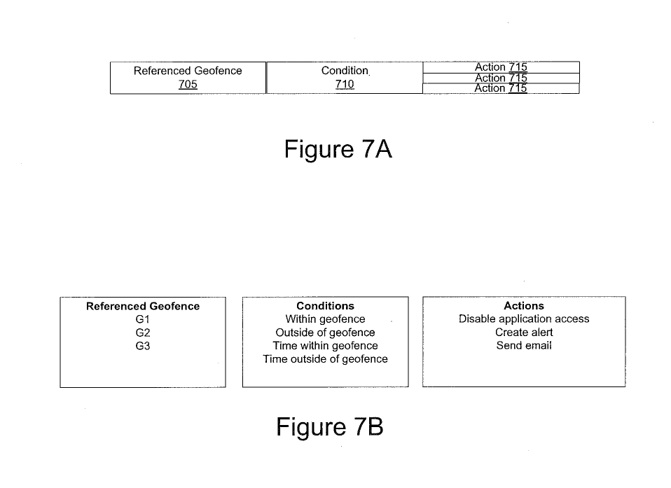

FIGS. 7A-7B illustrate an example format for defining geolocation targeting rules 210. The geolocation targeting rules 210 define resultant actions to be performed based on location and conditions relating to the virtual applications available on the computer device. In an embodiment, the geolocation targeting rules 210 are associated to the virtual application they reference and are part of the virtual application package 170 which is downloaded to the computer device 200 and made available to the end-user.

Conditions 710 for a referenced geofence 705 may include, for example, the device is within the geofence, the device is outside of the geofence, the device is approaching the geofence, the device is a defined distance from the geofence. Time can also add a dimension to the conditions such as elapsed time that the device is within the geofence, and elapsed time the device is outside of the geofence.

Resultant actions 715 based on the defined conditions may include, for example, removing access to the virtual application 110 by the virtual application agent 235 and retaining a cache of the virtual application, deleting the virtual application, disabling access to the AppPortal Server 300, alerting user of a geofence breach, notifying the AppPortal Server 300 of the breach, alerting AppPortal administrators or predefined users, disabling granular features of the virtual application, adjusting application license rights, or removing an application license. Removing access to the virtual application can result in a notification to the AppPortal Server 300 for a recovery of the license associated to the virtual application to be made available to other potential users of the virtualized application infrastructure.

Actions relating to the virtual application agent 235 are applied using interfaces in the virtual application agent. The virtual application can be instantly uninstalled or a streaming virtual application configuration can be removed from the virtual application agent, the AppPortal agent 234 can notify the user of the breach, the AppPortal agent 234 can send a notification of the breach to the AppPortal server, which may perform notifications to specified users by standard server based messaging or alert interfaces.

In an alternate embodiment, the geolocation targeting rules 210 may reference separately installed virtual applications 110 and may reference multiple geofences. Alternatively, the virtual application package 170 may not include a virtual application but include virtual application configuration information for which the AppPortal agent 234 may configure the parameters necessary for the virtual application agent 235 to access to a virtual application hosted by a separate streaming server 155.

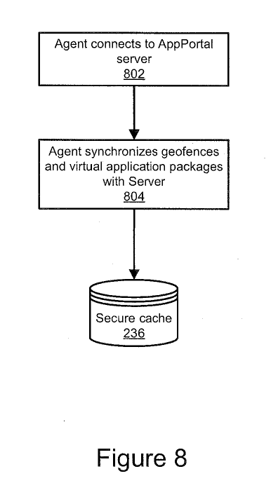

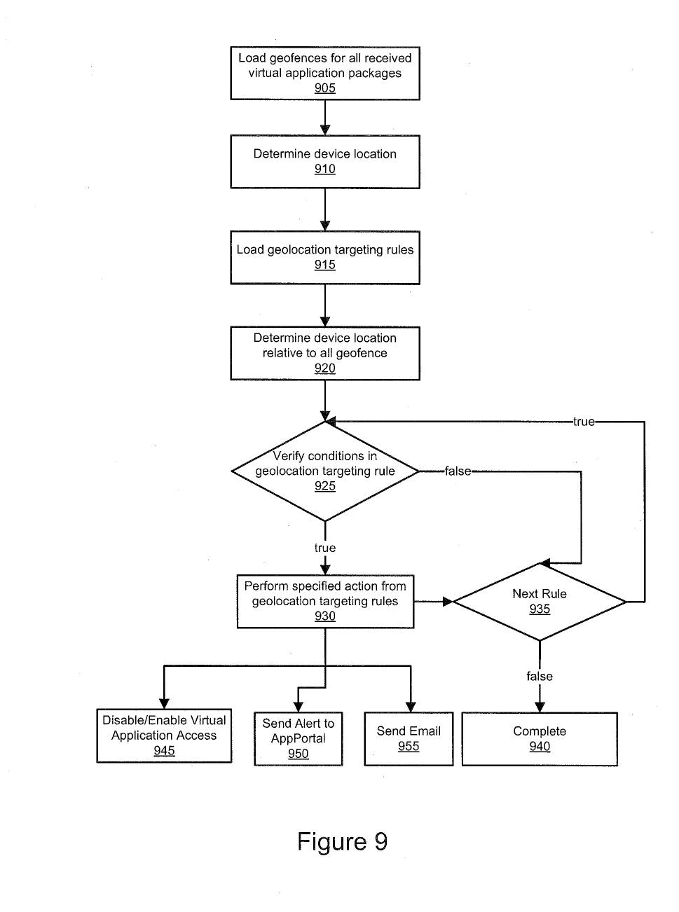

FIGS. 8 and 9 illustrate an example of a logic flow applied in the AppPortal agent 234 in managing access to virtual applications in the virtual application agent 235. In FIG. 8, the AppPortal agent 234 connects 802 and synchronizes data with the AppPortal Server 300. Synchronization 804 includes retrieval of a geofence list 215 and download of virtual application packages 170 made available to the end-user. The data may be stored in secure cache 236 in the device operating system to add security to the enforcement of the geolocation targeting rules 210. The AppPortal agent 235 receives virtual application package 170 from the AppPortal server. The virtual application package includes a virtual application 110 and geofence 120 specification. Additional information may also be contained in the virtual application package such as virtual application infrastructure parameters, application information, access control information related to the end-user.

Referring now to FIG. 9, the AppPortal agent 235 loads the geolocation targeting rules for virtual application packages at step 905. The current geolocation of the device is derived at step 910 from the current internet facing IP address of the network adapter 290 attached to the client device, or is determined using Device Operating System APIs which retrieve the latitude and longitude from the GPS adapter 280 connected to the device 200. The device location is determined relative to the geofences using known algorithms, such as computational geometry, known algorithms defined to address the point to polygon geometry problem, or third-party libraries used to interpret location-based telemetry relative to the standardized geofences within the geofence list. Simply, the agent determines whether the geographic location of the device is within or outside of the geofences in the geofence list at steps 915, 920. The first geolocation targeting rule is loaded and conditions for the geolocation targeting rules are checked at step 925, if the condition is met relative to the referenced geofence the actions specified in the geolocation targeting rules are applied 930 otherwise the next geolocation targeting rule is loaded and the conditions are verified 925. If all geolocation targeting rules have been processed the Agent geofence enforcement process is complete 940.

Some examples of the possible actions performed on the device and to the virtual application agent include disabling/enabling access 945, sending alerts to the AppPortal 950 and sending email messages 955. In disabling access to the virtual application, an API call to uninstall the application is sent to the virtual application agent. In enabling access to the virtual application, the virtual application may be retrieved from the secure cache or downloaded again from the AppPortal server and using an API call to the virtual application agent to install the virtual application the application is made available to the end-user.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the subject innovation.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of non-transitory computer readable medium, such as random access memory (RAM), read only memory (ROM), compact disk read only memory (CD-ROM), flash memory and so forth. In operation, a general purpose or application specific processor loads and executes the software in a manner well understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A computer device comprising:
a processor;
a memory storing a device operating system;
a cache storing a virtual application package that includes geofence policies associated with a virtual application; and
a first agent executing on the processor that is configured to load the geofence policies from the cache and to take action with respect to the virtual application based on the geofence policies and a geolocation information signal indicating the geolocation of the device.

2. The computer device of claim 1 in which the virtual application package includes the virtual application.

3. The computer device of claim 1 further comprising a second agent executing on the processor that is configured to operate the virtual application in isolation from the device operating system subject to the action taken by the first agent.

4. The computer device of claim 3 further comprising a network interface and in which the second agent accesses the virtual application hosted by a server through the network interface.

5. The computer device of claim 1 further including a global positioning system adapter that is configured to generate the geolocation information signal.

6. The computer device of claim 1 further including a network adapter that is configured to derive the geolocation information signal from an Internet network address.

7. The computer device of claim 1 in which each geofence policy includes a geofence that defines a geographical area and one or more conditions and corresponding actions associated therewith.

8. The computer device of claim 7 in which the first agent is further configured to take action to disable access to the virtual application for the condition where the geolocation information signal indicates the geolocation of the device is outside the defined geographical area of the geofence.

9. The computer device of claim 7 in which the first agent is further configured to take action to enable access to the virtual application for the condition where the geolocation information signal indicates the geolocation of the device is inside the defined geographical area of the geofence.

10. The computer device of claim 7 in which the first agent is further configured to take action to disable access to the virtual application for the condition where the geolocation information signal indicates the geolocation of the device is inside the defined geographical area of the geofence.

11. The computer device of claim 7 in which the first agent is further configured to take action to enable access to the virtual application for the condition where the geolocation information signal indicates the geolocation of the device is outside the defined geographical area of the geofence.

12. The computer device of claim 7 in which the first agent is further configured to take action with respect to the virtual application for the condition where the device is outside the defined geographical area of the geofence for a time duration.

13. The computer device of claim 7 in which the first agent is further configured to take action with respect to the virtual application for the condition where the device is inside the defined geographical area of the geofence for a time duration.

14. The computer device of claim 7 in which the first agent is further configured to take action to enable or disable access to the virtual application based on the geolocation of the device relative to the geofence.

15. The computer device of claim 14 in which the first agent enables a second agent executing on the processor to access the virtual application by allowing the second agent to retrieve the virtual application from the cache.

16. The computer device of claim 14 in which the first agent disables access to the virtual application by uninstalling the virtual application from the cache.

17. The computer device of claim 7 in which the first agent is further configured to take action to send a message based on the geolocation of the device relative to the geofence.

18. The computer device of claim 1 further comprising a network interface and in which the first agent is further configured to download the virtual application package from a virtual application server through the network interface.

19. The computer device of claim 1 further comprising a network interface and in which the first agent is further configured to download the geofence policies from a virtual application server through the network interface.

20. A server comprising:
a processor and a memory;
a database storing a plurality of virtual applications;
a geofence specification interface configured to define a plurality of geofence policies;
a virtual application administration interface configured to create a plurality of virtual application packages from the plural virtual applications and plural geofence policies; and
a network interface configured to deliver the virtual application packages to a plurality of computer devices.

21. The server of claim 20 which operates in a cloud computing environment.

22. The server of claim 20 in which the each geofence policy includes a geofence that defines a geographical area and one or more conditions and corresponding actions associated therewith.

23. The server of claim 22 in which the conditions include whether the computer device is inside or outside the geofence and a time duration for the computer device inside or outside the geofence, and the actions include enabling or disabling operation of the virtual application at the computer device based on the condition.

24. The server of claim 23 in which the actions further include sending a message based on the geolocation of the device relative to the geofence.

25. A method comprising:
storing in a cache of a computer device a virtual application package that includes geofence policies associated with a virtual application; and
loading the geofence policies from the cache and taking action with respect to the virtual application based on the geofence policies and a geolocation information signal indicating the geolocation of the device.

26. The method of claim 25 in which each geofence policy includes a geofence that defines a geographical area and one or more conditions and corresponding actions associated therewith.

27. The method of claim 26 in which taking action with respect to the virtual application occurs for the condition where the computer device is outside the defined geographical area of the geofence for a time duration.

28. The method of claim 26 in which taking action with respect to the virtual application occurs for the condition where the computer device is inside the defined geographical area of the geofence for a time duration.

29. The method of claim 26 in which taking action includes enabling or disabling access to the virtual application based on the geolocation of the computer device relative to the geofence.

30. The method of claim 26 in which taking action includes disabling access to the virtual application by uninstalling the virtual application from the cache.

31. The method of claim 26 in which taking action includes sending a message based on the geolocation of the computer device relative to the geofence.

32. The method of claim 25 including downloading the virtual application package from a virtual application server.

33. The method of claim 25 including downloading the geofence policies from a virtual application server.

34. A non-transitory computer readable medium comprising computer executable instructions for execution in a processor for:
storing in a cache of a computer device a virtual application package that includes geofence policies associated with a virtual application; and
loading the geofence policies from the cache and taking action with respect to the virtual application based on the geofence policies and a geolocation information signal indicating the geolocation of the computer device.

35. A method comprising:
storing a plurality of virtual applications;
defining a plurality of geofence policies;
creating a plurality of virtual application packages from the plural virtual applications and plural geofence policies; and
delivering the virtual application packages to a plurality of computer devices.

36. The method of claim 35 in which the each geofence policy includes a geofence that defines a geographical area and one or more conditions and corresponding actions associated therewith.

37. The method of claim 36 in which the conditions include whether the computer device is inside or outside the geofence and a time duration for the computer device inside or outside the geofence, and the actions include enabling or disabling operation of the virtual application at the computer device based on the condition.

38. A non-transitory computer readable medium comprising computer executable instructions for execution in a processor for:
storing a plurality of virtual applications;
defining a plurality of geofence policies;
creating a plurality of virtual application packages from the plural virtual applications and plural geofence policies; and
delivering the virtual application packages to a plurality of computer devices.
